(19) United States
(12) Patent Application Publication
(10) Pub. No.: US 2006/0194184 A1
(43) Pub. Date: Aug. 31, 2006

(54) Foreign language instruction over the internet

(76) Inventor: Geum S. Wagner, Clarksville, MD (US)

Correspondence Address: William S. Ramsey, 5253 Even Star Place, Columbia, MD, 21044, US

(21) Appl. No.: 11/066,579

(22) Filed: Feb. 25, 2005

(51) Int. Cl. G09B 3/00

(52) U.S. Cl. 434/350; 434/157

(57) ABSTRACT

This system provides cyber literary clubs over the internet. There is an emphasis on debate and discussion and writing in the foreign language. In one embodiment, native speaking teachers of the language engage in real time discussion via audio video and multimedia communications with students. Students in various physical locations read written novels, stories, newspapers, etc. in the language being studied. In another embodiment, students are instructed in more than one foreign language at a time. In another embodiment students are instructed in their native languages in academic subjects over the internet.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “MICROFICHE APPENDIX.”

Not Applicable.

### BACKGROUND OF THE INVENTION

1. Field of the Invention

This invention pertains to systems which use the internet in international foreign language instructions.

2. Description of Related Art Including Information Disclosed Under 37 CFR 1.97 and 37 CFR 1.98

This system provides foreign language instruction over the internet. In one embodiment, small groups of students from the member schools (of PROMISE Cyber School for All Nations) in a foreign country participate for live and interactive cyber reading club for foreign language novels in real time school or group setting via voice or video over IP moderated by a native speaking foreign language teacher either stationed within the country or stationed in the country of the language being used by the groups. In another embodiment, teams of compatible students in different countries join cyber international literary club to read foreign language novels, to discuss and to write essays as a part of improving the foreign language skills. In another embodiment students are instructed in more than one foreign language at a time by means of multimedia presentations of children's picture books. In another embodiment in America parent volunteers or paid teachers lead groups of small number of students to study in cyber schools as an after school program. In another embodiment members join cyber foreign novel reading clubs to read novels, discuss and write. This process assists immigrant families in maintaining their children's' proficiency in the families' mother tongue.

U.S. Pat. No. 6,296,489 discloses a sound file recording system using the internet for foreign language instruction in which the student records his or her speaking of the foreign language words and subsequently analyses the sounds using wave form analysis.

U.S. Pat. No. 6,302,695 discloses a native speaker of the language as a conversation partner and the internet for hosting asynchronous teaching conversations.

U.S. Pat. No. 6,741,833 discloses a system for using the internet for teaching a foreign language using text and voice. The system allows participants (students) to discuss the objectives with each other in order to develop cooperative solutions to posed questions.

US Pub. Pat. Applic. US 2002/0041328 discloses a system using the internet which provides simulated immersion in a foreign language using virtual reality nodes and digital video segments. The user is able to move linearly through the images which are viewed in conjunction with the foreign language discussion of the images.

US Pub. Pat. Applic. US 2002/0064767 discloses an internet system in which prospective students enter profile information which is used in the selection of a private instructor. This system is developed especially for language instruction and is designed to facilitate the matching of students and private instructors in a variety of different time zones.

US Pub. Pat. Applic. US 2002/0115044 discloses an internet system which recognizes a spoken phrase from a student even if the phrase departs from a desired pronunciation. The system responds by transmitting a computer generated version of the desired pronunciation of the phrase attempted by the student.

US Pub. Pat. Applic. US 2002/0169822 discloses an internet system in which a variety of subjects including language arts are taught. Multimedia methods are used to teach the pronunciation of various sounds in language instruction. Curricula are arranged for students from kindergarten through adults. The lessons are arranged in modules which comprise a content manager, a curriculum planner, instruction sequences and progress tracker.

The discovered prior art does not disclose a system of foreign language instruction over the internet with the advantages of the present invention, that of using native speaking teachers in real time reading of foreign language novels, anthologies and or an articles aloud by taking turns, discussing with guided questions and producing an essay based on what were read and discussed as a part of the foreign language curriculum at their schools and during their school hours.

### BRIEF SUMMARY OF THE EMBODIMENTS OF THE INVENTION

In one embodiment, the process comprises the following steps. Transmitting to the student in real time school setting during their school hours a literary reading in the foreign language and discussion guidelines. Discussing the reading based on the discussion guidelines amongst and by the student moderated by a teacher whose native language is the foreign language using the foreign language and synchronous, live and interactive voice or video techniques on the internet. Writing an essay as homework based on the reading and the discussion done. Transmitting the essay by the student to the teacher or to a designated grader. Grading, commenting and transmitting the grades and comments by the teacher or the grader to the student and the teachers of their own schools.

In another embodiment, the process comprises the following steps. Combining students from different countries having similar proficiency in the same foreign language into a small group. Transmitting to the student of the group a literary reading in the foreign language and discussion guidelines. Discussing based on the discussion questions of the same reading material amongst and by the members of the team moderated by a teacher whose native language is the foreign language using the foreign language and synchronous, live and interactive voice or video techniques on the internet. Writing an essay as homework based on the reading and discussion done by every student. Transmitting an essay by each student to the teacher or the grader. Grading, commenting, and transmitting the grades and the comments by the teacher or the grader to every student and to the teacher in their school.

In a third embodiment, the process of learning a foreign language by a group of students using the internet comprises the steps. Combining a group of students having a similar proficiency in the foreign language into a readers club. Transmitting to the club members readings in the foreign language. Discussing the reading by the members of the readers club using the foreign language and live and interactive voice or video techniques on the internet.

In a fourth embodiment the same processes of the third embodiment are used, with the exception that the language used is the student's native language. In this embodiment the students are taught a variety of subjects in addition to language arts, such as mathematics, science, and social studies.

One objective of embodiments of this invention is to provide a foreign language moderator or teacher whose native language is the foreign language being taught to the students to conduct a cyber reading club of the foreign novels with school children at their own schools during their school hours—over the internet.

Another objective of embodiments of this invention is to provide a cyber reading club of the foreign language novels to students in their real time school settings (secure from any harmful effects), over the internet using synchronous voice or video over IP to interact between foreign language teacher and students, in cooperation with schools, agencies, organizations and corporations.

Another objective of embodiments of this invention is to provide foreign language instruction to students with emphasis on live speaking opportunities and frequent writing assignments based on the novels read.

Another objective of embodiments of this invention is to train children as early as possible in multi foreign language abilities over the internet using multi media techniques.

Another objective of embodiments of this invention is to provide convenient, quality, effective and affordable foreign language training to students over the internet when students are organized in teams in the settings of schools, organizations, agencies or corporations.

Another objective of embodiments of this invention is to provide an exciting, challenging, convenient, affordable learning environment for foreign language and other subjects (as an after-school activity) to students over the internet with testing of the knowledge through game playing.

Another objective of embodiments of this invention is to provide international cyber reading clubs for foreign novels to teams of compatible students from different countries over the internet for cultural understanding and fostering of friendship amongst the members.

Another objective of embodiments of this invention is to provide a convenient means for families in which the parents are immigrants to foster and maintain proficiency among the parents and children in the use of the parent's native language.

Another objective of embodiments of this invention is to provide supplemental instruction and practice in academic subjects in a student's native language.

### BRIEF DESCRIPTION OF THE SEVERAL VIEWS OF THE DRAWINGS

FIG. 1 is a flow path schematic of the process of the first embodiment involving instruction of individual students.

FIG. 2 is a flow path schematic of the process of the second embodiment involving instruction of teams of students.

FIG. 3 is a flow path schematic of the process of the first embodiment involving the playing of games by the student.

FIG. 4 is a flow path schematic of the process of the second embodiment involving the playing of games by the teams of students.

FIG. 5 is a flow path schematic of the process of the third embodiment involving instruction of clubs of students.

### DETAILED DESCRIPTION OF THE EMBODIMENTS OF THE INVENTION

The processes of embodiments of this invention involve the use of the internet, an international computer network, to communicate with a teacher and a group student immersed studying the foreign language of their matched teacher. Accordingly embodiments of the invention require that both the teacher and the students have access to the internet and apparatus for communicating with the internet, most commonly a personal computer, but including wireless communication means such as cell phones, personal data assistants, and other suitable communication means.

In embodiments of this invention, the internet connection also must be capable of adequate bandwidth to accommodate real time or synchronous voice and multimedia communications, as well as written communications. Wire, optical waveguide, wireless or any other mode of internet access may be used.

Suitable communications means include personal computers such as those manufactured by Dell, Inc., of Austin Tex., or by Apple, Inc., of Palo Alto, Calif. The BLACKBERRY series of wireless technology devices available from Research In Motion Limited, Waterloo, Ontario, Canada is an example of suitable personal digital assistants. A suitable internet connection or conduit will have a bandwidth in the range of megabytes per second.

In the embodiments of this invention, reference to a “teacher” means a person who is a native speaker of the language such as Chinese, English, Korean, Spanish, etc., being taught. Reference to a “student” means a person of any age in any country who is interested in learning a foreign language that is a language which was not learned by the person as an infant. Embodiments of this invention do not require that the teacher and student know a language in common, other than the language which is being taught, although it may be desirable for the teaching process if the teacher and student have at least some proficiency in a common language other than that one being taught.

In the embodiments of this invention, it is expected that the teacher and student will be in different countries, although this is not necessary for the function of the embodiments. When teams or clubs of students are formed in embodiments of the invention, it is not necessary that members of the teams or clubs be resident in the same countries. It is not necessary that team or club members share knowledge of a common language other than the language being taught, although it may be desirable for the teaching process if the team or club members have at least some proficiency in a common language other than the one being taught.

In embodiments of this invention, it is anticipated that teachers, students, and members of teams or clubs of students may or may not be located in a common time zone. The only time zone requirement of embodiments of this invention is that teachers, students, and members of teams and clubs be available at the same time for synchronous conversations using the internet.

In embodiments of this invention, the term “literary reading” means written material which may be classics, novels, short stories, poems, essays, books, newspaper or magazine articles, or any other type of literature, including pictures and multimedia material. In particular, it is anticipated that the literary reading may include studies customarily classified as English, math, science, and social studies.

The term “discussion guideline” means any material intended to stimulate reflection, assessment, and analysis of the literary reading by the student. It includes questions, assertions, debating issues, and assignment of exercises for the student, all of which are designed to facilitate the student's mastery of the foreign language.

The term “essay” means any written material prepared by the student or team of students in response to the literary readings and guidelines provided by the teacher. Essays include short discussions of readings, short response or single word responses to questions, answers to mathematical problems, and sentence analysis.

In embodiments of this invention, the verb “transmit” means the use of any known process for the transfer of literary material. The internet will be the preferred conduit for such transmittals; but other means are also suitable and anticipated, such as books, pamphlets, brochures, CD's, tapes, or other recordings which are physically transferred, such as be mail or courier service or obtained from local booksellers or vendors or at libraries.

In embodiments of this invention, the term “multimedia” means information in audio or visual mode, such as speaking, singing, motion picture, or three-dimensional motion picture.

In embodiments of this invention, the term “student” means a person with an interest in improving his or her proficiency in a foreign language. It is anticipated that most students will be enrolled in elementary or secondary educational institutions, although the invention applies equally to preschool students and adult post-secondary education students who may or may not be enrolled in higher educational institutions.

In embodiments of this invention, it is preferred that teachers will be trained in foreign language being taught, although suitably motivated persons without formal training may participate as teachers and teacher assistants. It is important to embodiments of this invention that the teacher be a native speaker of the language being taught in order to insure adequate instruction in the nuances of pronouncing and usage of the language being taught. The role of the teacher includes, but is not limited to, correcting pronunciations, teaching grammar, encouraging student study of the parts of sentences, leading the literary reading discussions, and conducting and grading the games which measure student proficiency.

In embodiments of this invention the acquisition by students of proficiency in speaking the foreign language being taught is an important goal.

Although some embodiments of this invention require only that one foreign language is taught, it is anticipated and preferred that children from pre-kindergarten on will be engaged in learning of two foreign languages at the same time.

In preferred embodiments the instructional methods of this invention supplement and or enhance the foreign language instruction given the student in education programs in the student's country, rather than be the only source of foreign language instruction provided to the student. The instruction of younger students takes place in a school setting, although other settings may be used, including at home, in religious institutions, in agencies, organizations, and corporations.

The languages taught in embodiments of this invention are major languages of the worlds such as Arabic, Chinese, English, Hebrew, Korean, Spanish, Russian, etc. In preferred embodiments of the invention the teachers and students will reside in different countries, although it is not necessary that the teachers and students be located in different countries.

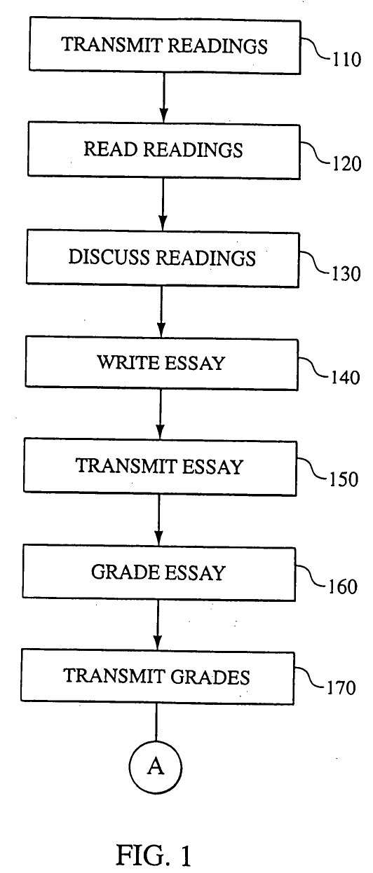

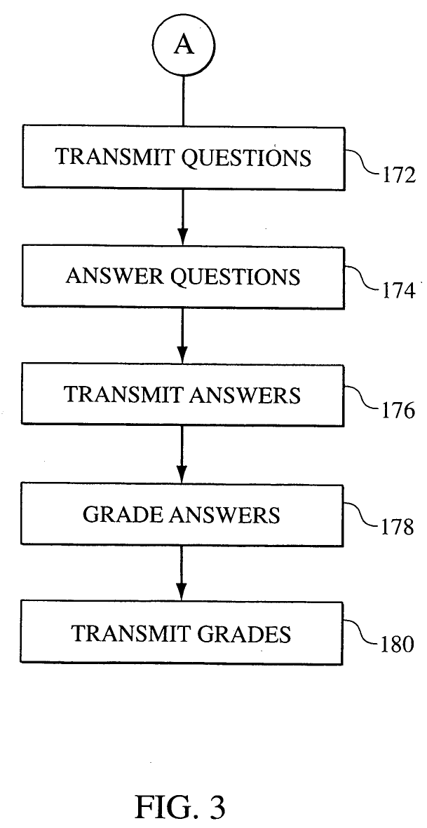

FIG. 1 is a flow path schematic of the process of the first embodiment involving instruction of individual students. In step 110 the teacher transmits literary readings and guidelines to the student. Preferably the readings and guidelines are in the form of conventional printed material, such as books, brochures, leaflets, newspapers, etc. These readings and guidelines and other communications in steps 110, 150, and 170 preferably are transmitted by conventional means, such as mail or courier delivery services, or local bookstores, vendors or libraries, although the internet may be used for the transmittal process. In step 120 the student reads the readings and guidelines and prepares for a discussion of the material. In step 130 the teacher and student discusses the readings and guidelines. Step 130 is conducted synchronously in real time using the foreign language and live and interactive voice or video techniques on the internet. In step 140 the student writes an essay as homework based on the readings and guidelines and discussions with the teacher. In step 150 the student transmits the essay to the teacher. The teacher grades the essay and writes comments indicating areas for improvement in step 160. In step 170 the teacher transmits the grades and comments to the student. Periodically, the student plays a game indicated at A in FIG. 1 and described in detail in FIG. 3.

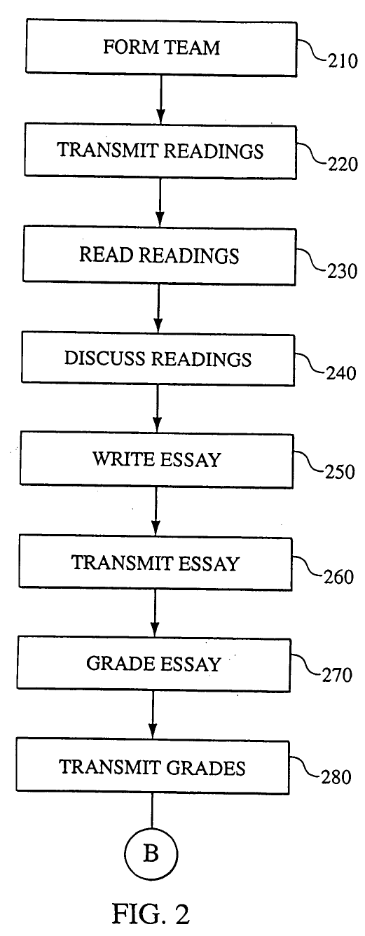

FIG. 2 is a flow path schematic of the process of the second embodiment involving instruction of teams of students. In step 210 the teacher forms a team of students of comparable proficiency in the foreign language being taught. In step 220 the teacher transmits literary readings and guidelines to each student in the team. Preferably the readings and guidelines are in the form of conventional printed material, such as books, brochures, leaflets, newspapers, etc. These readings and guidelines and other communications in steps 220, 250, and 270 preferably are transmitted by conventional means, such as mail or courier delivery services or local bookstores, vendors or library means, although the internet may be used for the transmittal process. In step 230 each student reads the readings and guidelines and prepares for a discussion. In step 240 the students discusses the readings and guidelines with the teacher. Step 240 is conducted synchronously in real time using the foreign language and live and interactive voice or video techniques on the internet. In step 250 each student of the student team writes an essay based on the literary readings, guidelines, and discussion. In step 260 each student transmits his or her essay to the teacher. In step 270 the teacher grades and enters comments on each essay. In step 280 the teacher transmits the grades and comments to each of the students in the team. Periodically, each student in the teams play a game indicated at B in FIG. 2 and described in detail in FIG. 3.

FIG. 3 is a flow path schematic of a portion of the process of the first embodiment involving the playing of on-line real time games by the student as indicated by A in FIG. 1. The game begins in step 172 when the teacher transmits questions to the student. In step 174 the student answers the questions and in step 176 transmits the answers to the teacher. The answers may be written or audio. In step 178 the teacher grades the answers and adds comments on the progress of the student. The results and the teacher's analysis of the game are transmitted to the student in step 180. The score of the student may be compared to the scores of other students.

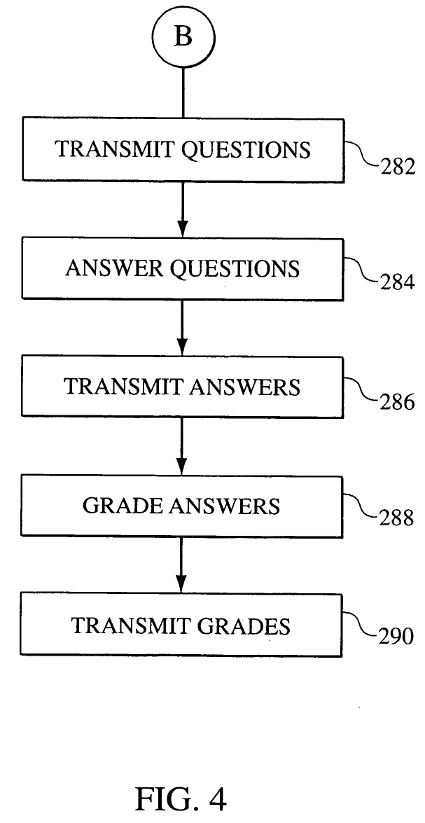

FIG. 4 is a flow path schematic of a portion of the process of the second embodiment involving the playing of on-line real time games by the teams of students as indicated by B in FIG. 2. The game begins in step 282 when the teacher transmits questions to the individual members of the student team. The individual students in a team may be physically located in a single site, such as in a school or church. Alternatively, the individual students may be dispersed to various locations within a country or between countries. In step 284 the individual students answer the questions. The answers may be written or audio. In step 286 each individual student transmits his or her answers to the teacher. In step 288 the teacher grades the answers and comments on the student's work and computes the collected scores of each team. The results and the teacher's analysis of the game are transmitted to the individual students in step 290. The score of each student team may be compared to the scores of other student teams.

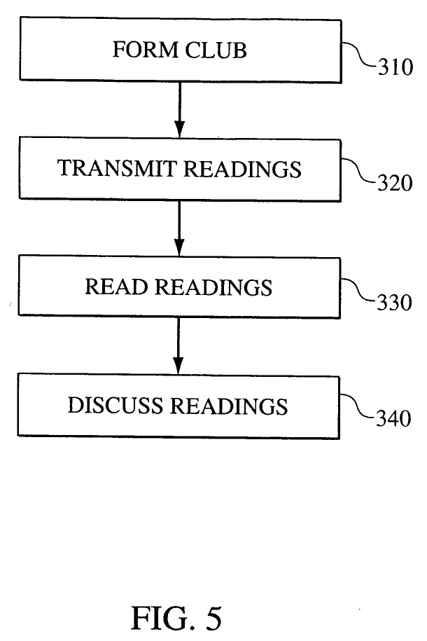

FIG. 5 is a flow path schematic of the process of the third embodiment involving instruction of clubs of students. In step 310 the teacher forms a club of students of comparable proficiency in the foreign language being taught. In step 320 the teacher transmits literary readings and guidelines to each student in the team as in the first embodiment. In step 330 the students read the readings. In step 340 the student club members discusses the readings with the teacher and with each other. Step 340 is conducted synchronously in real time using the foreign language and live and interactive voice or video techniques on the internet. It is not necessary that the club members reside in the same country or share the same native language.

The fourth embodiment of this invention uses the same processes of the third embodiment except the language used in the instruction of clubs of students is the students' native or mother language. In the fourth embodiment the subjects taught are academic subjects, such as language arts, science, mathematics and social studies. The fourth embodiment is intended to supplement and reinforce the student's education received from local educational institutions. In the fourth embodiment it is not necessary that the club members reside in the same country but it is necessary that they share the same native language.

Instructional Program

Students are presented certified diplomas after successful completion of each program.

Pre-Kindergarten to 2^{nd} Grade.

Instruction is provided in the form of multimedia presentations which include sing-along alphabet songs and read-along stories for two foreign languages. Children's' picture books in a variety of foreign languages are provided.

3^{rd} to 5^{th} Grade.

Read-along singing is provided in the form of multimedia presentations. The students begin to learn phonic sounds using read-aloud books with teacher using audio and or video communication over the internet. The students complete reading at least 300 easy-to-read books written in each of the two foreign languages being taught. Students in the 4^{th} grade and beyond write meaningful sentences. Students participate in an annual sing-a-song contest involving singing in the foreign language.

6^{th} to 8^{th} Grade.

Students are collected into groups of 7 to 10 students of comparable proficiency in the language and are taught as a group by one foreign language teacher. Students study grammar, read-aloud with the teacher on a variety of subjects, discuss the readings with guidelines, and write summaries and essays. Students will read and discuss award winning novels. Students participate in annual championship game.

9^{th} to 12^{th} Grade.

Students are collected into groups of 7 to 10 students of comparable proficiency in the language and are taught as a group by one teacher. Students continue to study grammar, read novels, world history, and other subjects, and write essays, and discuss the readings and writings. Students participate in annual championship game. Students participate in international foreign language speech competition.

College Students and Adults

Students are collected into groups of 6 to 10 students of comparable proficiency in the language and are taught as a group by one teacher. Students read novels, foreign newspapers, world history, and research and write essays, and report and discuss their work. The emphasis is on reading, discussing, and writing.

It will be apparent to those skilled in the art that the examples and embodiments described herein are by way of illustration and not of limitation, and that other examples may be used without departing from the spirit and scope of the present invention, as set forth in the appended claims.

I claim:

1. The process of instruction in a foreign language to a student by a teacher using the internet comprising the steps:
a. transmitting to the student a literary reading in the foreign language and a discussion guideline,
b. reading the literary reading and discussion guideline by the student,
c. discussing the reading and discussion guideline by the student and a teacher whose native language is the foreign language using the foreign language and synchronous, live and interactive voice or video techniques on the internet,
d. writing an essay based on the reading and guideline and discussion by the student,
e. transmitting the essay by the student to the teacher,
f. grading the essay and commenting on the essay by the teacher, and
g. transmitting the grades and comments by the teacher to the student.

2. The process of claim 1 wherein the student and the teacher are in different countries.

3. The process of claim 1 wherein the transmittal in steps a., e. or g. is via the internet.

4. The process of claim 1 wherein the transmittal in steps a., e. or g. is via conventional means.

5. The process of claim 1 wherein the process supplements instruction in the foreign language received by the student at an educational institute attended by the student.

6. The process of claim 1 wherein the discussion of step c. includes assistance to the student by the teacher in the foreign language pronunciation and usage.

7. The process of claim 1 further comprising the step following step g.:
h. playing a game wherein the foreign language proficiencies of one or more students are evaluated by the teacher.

8. The process of claim 7 wherein the game comprises the steps:
a′. transmitting questions to the student by the teacher,
b′. answering the questions by the student,
c′. transmitting the answers by the student to the teacher,
d′. grading the answers and commenting on the answers by the teacher, and
e′. transmitting the grades and comments by the teacher to the student.

9. The process of claim 7 wherein the game is played using the internet.

10. The process of instruction in a foreign language to a group of students by a teacher using the internet comprising the steps:
a. combining a group of students having similar proficiency in the foreign language into a team,
b. transmitting to the student members of the team a literary reading in the foreign language and a discussion guideline,
c. reading the literary reading and discussion guideline by the students,
d. discussing the reading and essay by each member of the team and a teacher whose native language is the foreign language using the foreign language, synchronous and live and interactive voice or video techniques on the internet,
e. writing an essay based on the reading and guideline and discussion by each member of the team of students,
f. transmitting an essay by each member of the team of students to the teacher,
g. grading the essays and commenting on the essays by the teacher, and
h. transmitting the grades and comments by the teacher to each member of the team of students.

11. The process of claim 10 wherein the teacher and at least one member of the team are in at least two different countries.

12. The process of claim 10 wherein the students are in at least two different countries.

13. The process of claim 10 wherein the transmittal in step b., f., or h. is via the internet.

14. The process of claim 10 wherein the transmittal in step b. f. or h. is via conventional means.

15. The process of claim 10 wherein the students in the team formed in step a. do not share the same native language.

16. The process of claim 10 wherein the process supplements instruction in the foreign language received by the student at an educational institute attended by the student.

17. The process of claim 10 wherein the discussion of step d. includes assistance to the student by the teacher in the foreign language pronunciation and usage.

18. The process of claim 10 further comprising the step following step h.:
i. playing a game by the student team members wherein the foreign language proficiencies of more than one team are evaluated and compared.

19. The process of claim 18 wherein the game comprises the steps:
a′. transmitting questions to the students by the teacher,
b′. answering the questions by the students,
c′. transmitting the answers by the students to the teacher,
d′. grading the answers and commenting on the answers by the teacher, and
e′. transmitting the grades and comments by the teacher to the students.

20. The process of claim 19 wherein the game is played using the internet.

21. The process of learning a foreign language by a group of students using the internet comprising the steps:
a. combining a group of students having a similar proficiency in the foreign language into a readers club,
b. transmitting to the club members readings in the foreign language, and
c. discussing the reading by the members of the readers club using the foreign language and live and interactive voice or video techniques on the internet.

22. The process of claim 21 wherein the club members are in at least two countries.

23. The process of claim 21 wherein the readings are transmitted via the internet.

24. The process of claim 21 wherein the readings are transmitted via conventional means.

25. The process of claim 21 wherein the club members do not all share the same native language.

26. The process of learning an academic subject by a group of students using the internet comprising the steps:
a. combining a group of students having a similar proficiency in the academic subject and the same native language into a readers club,
b. transmitting to the club members readings in the student's native language, and
c. discussing the readings by the members of the readers club using the student's native language and live and interactive voice or video techniques on the internet.

27. The process of claim 26 wherein the academic subjects are language arts, mathematics, science, or social studies.

28. The process of claim 26 wherein the club members are in at least two countries.

29. The process of claim 26 wherein the readings are transmitted via the internet.

30. The process of claim 26 wherein the readings are transmitted via conventional means.
